(19) United States
(12) Patent Application Publication
(10) Pub. No.: US 2025/0226718 A1
(43) Pub. Date: Jul. 10, 2025

(54) MOTOR

(71) Applicant: MINEBEA MITSUMI Inc., Kitasaku-gun, Nagano (JP)

(72) Inventors: Kentaro SUZUKI, Kitasaku-gun, Nagano (JP); Kouji KEBUKAWA, Kitasaku-gun, Nagano (JP)

(21) Appl. No.: 18/850,768

(22) PCT Filed: Dec. 19, 2022
(86) PCT No.: PCT/JP2022/046607

§ 371 Date: Nov. 13, 2024

(30) Foreign Application Priority Data
Mar. 28, 2022 (JP) 2022-052301

(51) Int. Cl. H02K 5/173; H02K 7/08; H02K 21/22

(52) U.S. Cl. CPC H02K 5/1737; H02K 7/088; H02K 21/22

(57) ABSTRACT

One of the objects is to provide a motor capable of suppressing a reduction of a lifespan. A motor includes a shaft, a first bearing disposed at one side in an axial direction of the shaft, a second bearing disposed at another side in the axial direction of the shaft, and a bearing housing being a holding member configured to hold the first bearing and the second bearing. In the radial direction, a distance between the first bearing and the holding member is smaller than a distance between the second bearing and the bearing housing.

### TECHNICAL FIELD

The present invention relates to a motor.

### BACKGROUND ART

In related art, a fan motor with a plurality of blades attached to the outer side of a driving unit is known. Such a driving unit of a fan motor may include, at an inner part, a bearing device including a shaft, a pair of bearings attached to the shaft, and a bearing holder supporting the pair of bearings from the outer side in the radial direction (for example, see Patent Document 1).

### CITATION LIST

### Patent Literature

Patent Document 1: JP 2009-247143 A

### SUMMARY OF INVENTION

### Technical Problem

However, in manufacturing such a bearing device of the related art, the pair of bearings is easily damaged, and as a result, the lifespan of the motor tends to be easily reduced.

Thus, one of problems addressed by the present invention is to provide a motor capable of suppressing a reduction of a lifespan.

### Solution to Problem

The above-described problem is solved by the present invention described below. Specifically, a motor of the present invention includes a shaft, a first bearing disposed at one side in an axial direction of the shaft, a second bearing disposed at another side in the axial direction of the shaft, and a holding member configured to hold the first bearing and the second bearing. In a radial direction, a distance between the first bearing and the holding member is smaller than a distance between the second bearing and the holding member.

### BRIEF DESCRIPTION OF DRAWINGS

FIG. 1 is a perspective view illustrating an overall configuration of a motor according to an embodiment of the present invention.

FIG. 2 is a cross-sectional view along a direction of an axis X of a shaft of the motor illustrated in FIG. 1.

FIG. 3 is an enlarged view illustrating a bearing device illustrated in FIG. 2 in a simplified manner.

FIG. 4 is a view illustrating an initial step of a manufacturing process of the bearing device illustrated in FIG. 3.

FIG. 5 is a view illustrating an intermediate step of the manufacturing process of the bearing device illustrated in FIG. 3.

FIG. 6 is a view illustrating a final step of the manufacturing process of the bearing device illustrated in FIG. 3.

FIG. 7 is a view illustrating, in a simplified manner, a holding member in a modified example of the bearing device illustrated in FIG. 3.

### DESCRIPTION OF EMBODIMENTS

Hereinafter, an embodiment of a motor according to the present invention will be illustrated with reference to the accompanying drawings. In the above-described accompanying drawings, in order to facilitate understanding, the dimensions of each member may be exaggerated or reduced, or the configuration may be illustrated in a simplified manner.

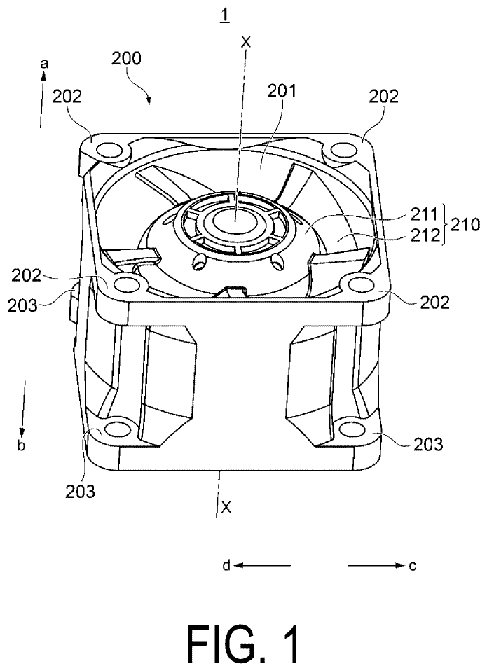

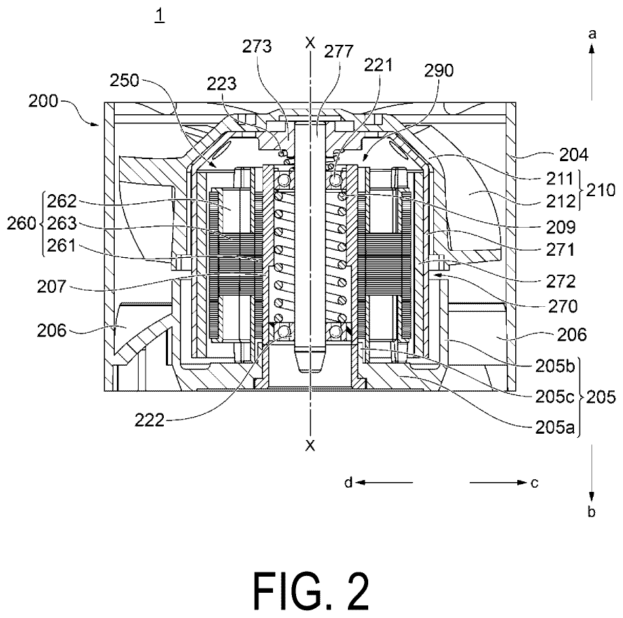

FIG. 1 is a perspective view illustrating an overall configuration of a motor according to an embodiment, and FIG. 2 is a cross-sectional view along a direction of an axis X of the motor illustrated in FIG. 1.

A motor 1 according to the embodiment is constituted as an axial fan motor, and functions as an axial blower blowing an air flow in the direction of the axis X. As illustrated in FIGS. 1 and 2, the motor 1 includes a casing 200, an impeller 210, and a driving unit 250 as main components.

First, the casing 200 will be described.

The casing 200 has a substantially square tubular shape in a plan view, and an internal space of the casing 200 forms a wind tunnel with an air flow flowing from an upper end (an end part at the upper side (arrow a direction) in the direction of the axis X) toward a lower end (an end part at the lower side (arrow b direction) in the direction of the axis X). That is, an intake port 201 for sucking air into the internal space is formed at the upper end of the casing 200, and an exhaust port for discharging air is formed at the lower end of the casing 200. In such an internal space of the casing 200, the impeller 210, the driving unit 250, and the like described above are accommodated.

The casing 200 includes a side wall 204, a base part 205, and fixed blades 206.

The side wall 204 surrounds the impeller 210 from the radial direction (arrows cd directions) perpendicular to the direction of the axis X, and is connected to the above-described upper end. The side wall 204 has a cylindrical shape centered around the axis X and has an inner diameter not coming into contact with the outer peripheral end of a blade 212, of the impeller 210, described later. That is, a predetermined clearance is formed between the outer peripheral end of the blade 212 of the impeller 210 and the inner peripheral surface of the side wall 204. The side wall 204 also functions as a guard part protecting the impeller 210.

The fixed blades 206 are constituted by a plurality of stationary blades, and the side wall 204 and the base part 205 are connected to each other in the radial direction by the fixed blades 206.

The base part 205 includes a lower end part 205a having a disc shape and forming the above-described lower end of the casing 200, a cylindrical outer peripheral wall 205b extending along the axis X from an outer-peripheral-side end part of the lower end part 205a to the upper side by a predetermined length, and a boss part 205c protruding along the axis X from an end part at the inner peripheral side of the lower end part 205a to the upper side by a predetermined length.

The fixed blades 206 are integrally formed at the outer peripheral surface of the outer peripheral wall 205b. That is, the outer peripheral wall 205b is supported by the side wall 204 of the casing 200 via the fixed blades 206. A bearing housing 207 described later is attached to the inner peripheral surface of a boss part 205c of the base part 205. As will be described later, the bearing housing 207 is a part of a bearing device 290 of the driving unit 250.

These side wall 204, base part 205, and fixed blades 206 of the casing 200 may be integrally formed by injection molding of a synthetic resin (e.g., a polybutylene terephthalate resin (containing glass fibers)). Alternatively, instead of the fixed blades 206 connecting the side wall 204 and the base part 205, a plurality of spokes constituted by rod-like parts may be used.

Note that the casing 200 of the present embodiment includes four upper flange parts 202 at corners of the upper end, and four lower flange parts 203 at corners of the lower end. In the present embodiment, each of the upper flange parts 202 and each of the lower flange parts 203 are formed integrally with the side wall 204. Each of these upper flange parts 202 and lower flange parts 203 is provided with a through-hole, and a bolt (not illustrated) for attachment to a predetermined apparatus or housing is inserted into the through-hole.

Next, the impeller 210 will be described.

As illustrated in FIG. 2, the impeller 210 includes a bottomed cup-shaped hub 211 having a cross section of a substantially inverted U-shape, and a plurality of blades 212 provided along the circumferential direction at the outer peripheral surface of the hub 211. The hub 211 and the plurality of blades 212 may be integrally formed by injection molding of a synthetic resin (e.g., a polybutylene terephthalate resin (containing glass fibers)), for example.

The hub 211 is bonded, with an adhesive material, to the outer peripheral surface, at the upper side of a rotor yoke 271 described later, of the driving unit 250. However, this is not limited, and the rotor yoke 271 may be inserted into the hub 211 to integrally form the inner peripheral surface of the hub 211 and the outer peripheral surface of the rotor yoke 271. In this way, in the present embodiment, the hub 211 is formed integrally with the rotor yoke 271. Further, the hub 211 covers an end part, at an upper side, of a shaft 277 to prevent foreign matters from entering from the outside. Note that, in the present embodiment, a coil spring 223 for applying a preload to a first bearing 221 described later is disposed between the hub 211 and the first bearing 221 in the direction of the axis X.

The plurality of blades 212 have substantially the same shape, and are disposed at substantially equal intervals in the circumferential direction of the hub 211.

Next, the driving unit 250 will be described.

As illustrated in FIG. 2, the driving unit 250 includes a stator part 260, a rotor part 270, and the bearing device 290 as main components.

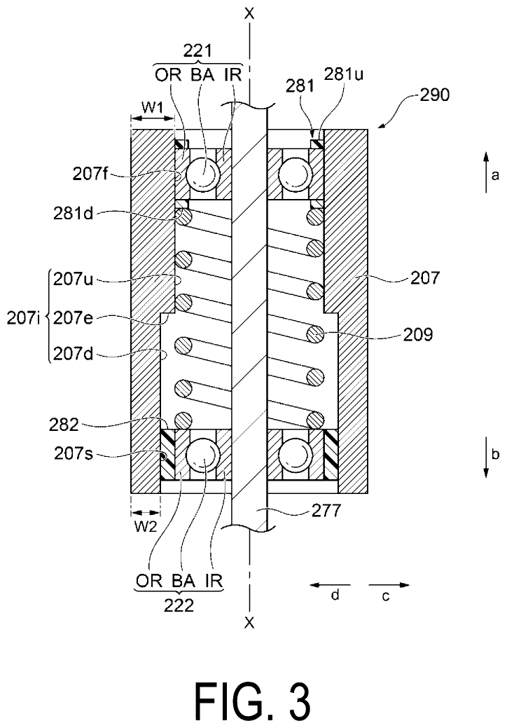

The bearing device 290 of the driving unit 250 is located at the innermost side of the driving unit 250. FIG. 3 is an enlarged view illustrating the bearing device 290 in a simplified manner, and is a cross-sectional view, along the direction of the axis X, of the bearing device 290. As illustrated in FIGS. 2 and 3, the bearing device 290 includes the shaft 277, a coil spring 209, the first bearing 221, a second bearing 222, and the bearing housing 207 as main components.

The shaft 277 of the bearing device 290 is located at the center of the motor 1 and has the above-described axis X as the central axis. The shaft 277 is press-fitted into a bush 273, described later, of the rotor part 270, and extends in the direction of the axis X from the vicinity of the upper end to the vicinity of the lower end of the motor 1.

The first bearing 221 and the second bearing 222 of the bearing device 290 have substantially the same configuration and dimensions, and are ball bearings including an inner ring IR, an outer ring OR, and a plurality of balls BA provided between the inner ring IR and the outer ring OR. The first bearing 221 is provided above the second bearing 222, and the second bearing 222 is provided below the first bearing 221. The inner ring IR of each of the first bearing 221 and the second bearing 222 is press-fitted to the shaft 277. Note that the first bearing 221 and the second bearing 222 are not limited to the ball bearings.

In this way, the first bearing 221 supports a part, at an upper side, of the shaft 277 in the direction of the axis X so that the shaft 277 can rotate, and the second bearing 222 supports a part, at a lower side, of the shaft 277 in the direction of the axis X so that the shaft 277 can rotate. That is, the shaft 277 is supported by the first bearing 221 and the second bearing 222 so as to be rotatable with respect to the stator part 260.

The coil spring 209 of the bearing device 290 is disposed between the first bearing 221 and the second bearing 222, and applies a pressure to the first bearing 221 and the second bearing 222.

The bearing housing 207 of the bearing device 290 is made of a hollow cylindrical metal material, and a lower end part of the bearing housing 207 is press-fitted into the boss part 205c of the casing 200. In this way, the bearing housing 207 is supported by the casing 200 and extends in the direction of the axis X. Note that, in the present embodiment, the bearing housing 207 is press-fitted into the boss part 205c. However, while not being limited to this, the bearing housing 207 may be integrally formed with the base part 205 in a state of the bearing housing 207 being inserted into the boss part 205c.

As illustrated in FIG. 3, an inner peripheral surface 207i of the bearing housing 207 is not flush, and at least a part 207f, opposing the first bearing 221, of the inner peripheral surface 207i, protrudes to the inner side in the radial direction (the radial direction d side). Therefore, the bearing housing 207 is constituted such that a width W1 of a surface, opposing the first bearing 221, of the bearing housing 207 is larger than a width W2 of a surface, opposing the second bearing 222, of the bearing housing 207 in the radial direction. In the present embodiment, the inner peripheral surface 207i of the bearing housing 207 includes a lower surface 207d extending along the direction of the axis X from the lower end of the inner peripheral surface 207i to approximately half the height of the inner peripheral surface 207i, a stepped surface 207e extending toward the inner side in the radial direction from the upper end of the lower surface 207d, and an upper surface 207u extending along the direction of the axis X from an end part, at an inner side in the radial direction, of the stepped surface 207e to the upper end of the inner peripheral surface 207i. The upper surface 207u includes the part 207f opposing the first bearing 221, and the lower surface 207d includes a part 207s opposing the second bearing 222.

Incidentally, if the inner peripheral surface 207i is flush, the distance between the outer peripheral surface of the outer ring OR of the first bearing 221 and the inner peripheral surface 207i of the bearing housing 207 is equal to the distance between the outer peripheral surface of the outer ring OR of the second bearing 222 and the inner peripheral surface 207i of the bearing housing 207 in the radial direction. However, in the present embodiment, as described above, since at least the part 207f, opposing the first bearing 221, of the inner peripheral surface 207i protrudes to the inner side in the radial direction, the distance between the outer peripheral surface of the outer ring OR of the first bearing 221 and the inner peripheral surface 207i of the bearing housing 207 is smaller than the distance between the outer peripheral surface of the outer ring OR of the second bearing 222 and the inner peripheral surface 207i of the bearing housing 207 in the radial direction.

An adhesive material 282 is filled in a clearance between the outer peripheral surface of the outer ring OR of the second bearing 222 and the inner peripheral surface 207i of the bearing housing 207, and the outer ring OR of the second bearing 222 is bonded to the inner peripheral surface 207i of the bearing housing 207 via the adhesive material 282. In this way, in the motor 1, the bearing housing 207 and the outer ring OR of the second bearing 222 are bonded to each other such that the angle between the bearing housing 207 and the outer ring OR of the second bearing 222 is substantially 90°, and the inner ring IR of the second bearing 222 is press-fitted to the shaft 277 as described above. Thus, the second bearing 222 is supported by the shaft 277 at an angle of substantially 90° with respect to the shaft 277. That is, in the motor 1, the second bearing 222 is attached substantially perpendicularly to each of the shaft 277 and the bearing housing 207 extending in the direction of the axis X.

An adhesive material 281 is filled in a clearance between the outer peripheral surface of the outer ring OR of the first bearing 221 and the inner peripheral surface 207i of the bearing housing 207. The adhesive material 281 may be made of the same material as the adhesive material 282, or may be made of a different material. The adhesive material 281 protrudes to at least one of the upper side and the lower side of the first bearing 221 due to the distance between the outer peripheral surface of the outer ring OR of the first bearing 221 and the inner peripheral surface 207i of the bearing housing 207 being smaller than the distance between the outer peripheral surface of the outer ring OR of the second bearing 222 and the inner peripheral surface 207i of the bearing housing 207 in the radial direction, and the like. In the present embodiment, the adhesive material 281 includes a first part 281u protruding to the upper side of the first bearing 221 and a second part 281d protruding to the lower side of the first bearing 221. The outer ring OR of the first bearing 221 is bonded to the inner peripheral surface 207i of the bearing housing 207 by such an adhesive material 281. In this way, in the motor 1, the bearing housing 207 and the outer ring OR of the first bearing 221 are bonded to each other such that the angle between the bearing housing 207 and the outer ring OR of the first bearing 221 is substantially 90°, and the inner ring IR of the first bearing 221 is press-fitted to the shaft 277 as described above. Thus, the first bearing 221 is supported by the shaft 277 at an angle of substantially 90° with respect to the shaft 277. That is, in the motor 1, the first bearing 221 is attached substantially perpendicularly to each of the shaft 277 and the bearing housing 207 extending in the direction of the axis X.

Note that, in the present embodiment, as described above, the first bearing 221 and the bearing housing 207 are fixed by the adhesive material, and the second bearing 222 and the bearing housing 207 are fixed by the adhesive material. However, while not being limited to this, at least one of the first bearing 221 and the second bearing 222 may be fixed to the bearing housing by another method such as fixing via an elastic member or a member having viscosity or adhesiveness.

In this way, the bearing housing 207 functions as a holding member capable of holding each of the first bearing 221 and the second bearing 222 substantially perpendicularly to the shaft 277.

As illustrated in FIG. 2, the stator part 260 of the driving unit 250 includes a stator core 261, an insulator 262, and a coil 263.

In the present embodiment, the stator core 261 of the stator part 260 is formed by a stacked body constituted by stacking a plurality of cores of electromagnetic steel sheets made of a soft magnetic material. In the present embodiment, a circular opening part is formed at the inner peripheral surface of the stator core 261, and the outer peripheral surface of the bearing housing 207 is fitted to this opening part. In this manner, the stator core 261 is attached to the bearing housing 207, and is located at the outer side in the radial direction (the radial direction c side) with respect to the bearing housing 207. Note that the stator core 261 may be attached to the bearing housing 207 by additionally using an adhesive material.

The insulator 262 of the stator part 260 is made of an insulating material, and is attached to the stator core 261 to cover the stator core 261. The coil 263 of the stator part 260 is wound around the stator core 261 via the insulator 262. In this way, since the coil 263 is wound around the stator core 261 via the insulator 262, the stator core 261 and the coil 263 are insulated by the insulator 262.

As illustrated in FIG. 2, the rotor part 270 of the driving unit 250 includes the rotor yoke 271, a magnet 272, and the bush 273 as main components.

The rotor yoke 271 has a hollow cylindrical shape and is made of a soft magnetic material, for example. The rotor yoke 271 is disposed further to the outer side in the radial direction than the coil 263 of the stator part 260. The magnet 272 is formed in an annular shape and is disposed at the inner peripheral surface of the rotor yoke 271. That is, the magnet 272 is disposed, in the radial direction, between the coil 263 of the stator part 260 located at the inner side and the rotor yoke 271 located at the outer side, and opposes the coil 263. Each of the rotor yoke 271 and the magnet 272 is disposed coaxially with the shaft 277.

The bush 273 is made of a soft magnetic material, for example, and is connected to an upper end part of the rotor yoke 271 to cover the upper part of the rotor yoke 271. For example, the bush 273 may be attached to the rotor yoke 271 by integrally fixing the inner peripheral edge of the rotor yoke 271 to the outer peripheral edge of the bush 273 by caulking. A concave part is formed at the center of the bush 273, and the shaft 277 is press-fitted into the concave part.

In the present embodiment, the rotor yoke 271, the magnet 272 are integrally formed via the hub 211, and the shaft 277 is integrally formed with the hub 211 via the bush 273. In this way, in the present embodiment, the rotor yoke 271 of the rotor part 270 is integrally attached to the impeller 210. Therefore, in the motor 1 of the present embodiment, when the rotor yoke 271 rotates around the shaft 277 due to the electromagnetic action generated between the coil 263 of the stator part 260 and the magnet 272 of the rotor part 270, the impeller 210 rotates together with the rotor yoke 271, thus operating as an outer rotor motor. That is, the rotor part 270 is integrated with the blades 212 by the hub 211 integrally attached to the rotor yoke 271, and functions as a rotating body.

As described above, the motor 1 includes the shaft 277, the first bearing 221 disposed at one side (upper side) of the shaft 277 in the direction of the axis X, the second bearing 222 disposed at the other side (lower side) of the shaft 277 in the direction of the axis X, and the bearing housing 207 (holding member) holding the first bearing 221 and the second bearing 222. In the radial direction, the distance between the first bearing 221 and the bearing housing 207 is smaller than the distance between the second bearing 222 and the bearing housing 207.

In this motor 1, the distance between the first bearing 221 and the bearing housing 207 is configured to be smaller than the distance between the second bearing 222 and the bearing housing 207. Thus, as will be described in a manufacturing method for the bearing device 290 described later, when manufacturing the bearing device 290, the first bearing 221 is inhibited from being attached in a state of being inclined with respect to the shaft 277 (in other words, when the angle formed between the shaft 277 and the first bearing 221 deviates from) 90°. Thus, during the operation of the motor 1, damage to the first bearing 221 resulting from the first bearing 221 receiving a load generated by the inclination of the first bearing 221 with respect to the shaft 277 is suppressed. Then, the first bearing 221 is inhibited from being damaged, and thus, the shaft 277 is inhibited from being inclined as a result of the first bearing 221 being damaged. As a result, the second bearing 222 is inhibited from being further damaged as a result of the shaft 277 being inclined. In this way, in the motor 1, since the first bearing 221 and the second bearing 222 are inhibited from being damaged, it is possible to inhibit the lifespan of the motor from being reduced.

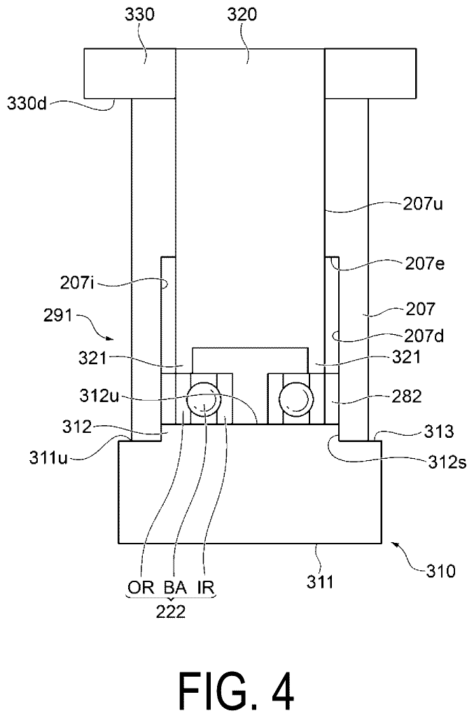

Next, an example of a manufacturing method for the above-described bearing device 290 will be described with reference to FIGS. 4 to 6. Note that although FIGS. 4 to 6 are cross-sectional views similar to FIG. 3, hatching is omitted for convenience.

First, as illustrated in FIG. 4, a first jig 310, a second jig 320, and a third jig 330 are prepared, and a first step is performed.

The first jig 310 has a substantially columnar shape and is flat in the horizontal direction. The first jig 310 includes a first part 311 having a rectangular shape being a relatively large shape in a cross-sectional view along the vertical direction, and a second part 312 having a rectangular shape being a smaller shape in the cross-sectional view along the vertical direction than the first part 311. The first part 311 and the second part 312 are integrally formed, and the second part 312 is located above the first part 311. With such a configuration, the outer peripheral edge of the first jig 310 forms a corner part 313. At the corner part 313, an upper surface 311u of the first part 311 and a side surface 312s of the second part 312 form the angle of 90°. The diameter of the second part 312 is substantially the same as the diameter of the lower surface 207d of the inner peripheral surface 207i of the bearing housing 207, and is larger than the outer diameter of the second bearing 222 (i.e., the diameter of the outer ring OR of the second bearing 222) by a predetermined length.

The second jig 320 has a substantially columnar shape elongated in the vertical direction, and a protruding part 321 having a cylindrical and ring-shaped outer shape protrudes downward from the outer edge of the lower end surface of the second jig 320. The diameter of the second jig 320 is slightly smaller than the diameter of the upper surface 207u of the inner peripheral surfaces 207i of the bearing housings 207, and is substantially equal to the outer diameter of the second bearing 222. The third jig 330 has a cylindrical and ring-shaped outer shape, and the inner diameter of the third jig 330 is slightly larger than the diameter of the second jig 320. Therefore, the second jig 320 can pass through the space inside the third jig 330.

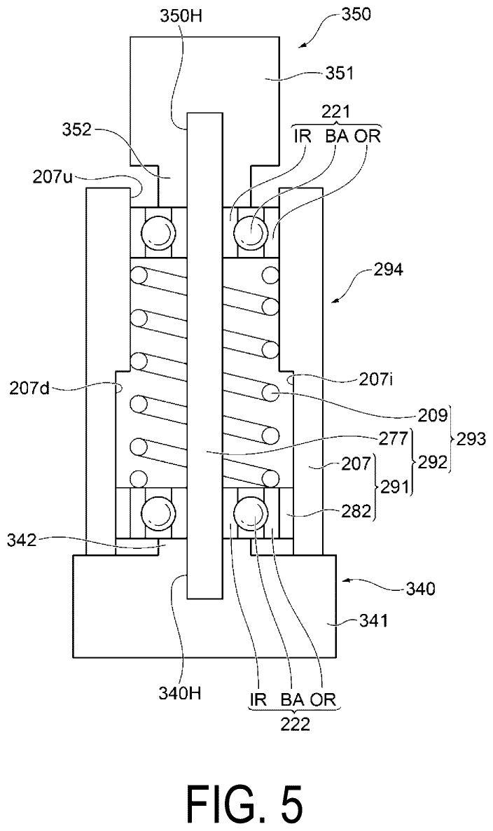

In the first step, after the first jig 310 is placed at a horizontal surface, the second bearing 222 having the adhesive material 282 applied to the outer peripheral surface (the outer peripheral surface of the outer ring OR) is placed at an upper surface 312u of the second part 312 of the first jig 310. At this time, the center of the upper surface 312u of the second part 312 is aligned with the center of the second bearing 222. Subsequently, while maintaining this state, the protruding part 321 of the second jig 320 is brought into contact with the second bearing 222 so that the outer peripheral surface of the protruding part 321 of the second jig 320 is substantially flush with the outer peripheral surface of the second bearing 222. In this way, the second bearing 222 is held from above and below in the vertical direction by the first jig 310 and the second jig 320. Subsequently, after the lower end part of the bearing housing 207 is fitted to the corner part 313 of the first jig 310, the third jig 330 is fitted to the outer side of the second jig 320 from above, and a lower surface 330d of the third jig 330 is brought into contact with the upper surface of the bearing housing 207. In this way, the bearing housing 207 is held by the first jig 310 and the third jig 330 from above and below in the vertical direction, and the bearing housing 207 and the second bearing 222 are held in a state of the angle formed between the bearing housing 207 and the second bearing 222 being 90°. This state is maintained until the adhesive material 282 solidifies. As a result, a first assembly 291 (see FIG. 5) is obtained. In the first assembly 291, the bearing housing 207 and the second bearing 222 are bonded to each other by the adhesive material 282 in a state of the angle formed between the bearing housing 207 and the second bearing 222 being substantially 90°. As described above, the first step is a step of vertically fixing the second bearing 222 to the bearing housing 207 being the holding member.

Note that, as described above, since the diameter of the second part 312 of the first jig 310 is larger than the outer diameter of the second bearing 222 by the predetermined length, in the first step, a certain amount of clearance is formed in the radial direction between the lower surface 207d of the inner peripheral surface 207i of the bearing housing 207 and the outer peripheral surface of the second bearing 222. Thus, the adhesive material 282 filled in the clearance is hardly pressed by the inner peripheral surface 207i of the bearing housing 207 and the outer peripheral surface of the second bearing 222, and does not protrude to the upper side or the lower side of the second bearing 222, or even if it protrudes, an amount of the adhesive material 282 is negligibly small.

Subsequently, after the first jig 310, the second jig 320, and the third jig 330 are removed, a second step is performed.

In the second step, as illustrated in FIG. 5, the second bearing 222 of the first assembly 291 is supported from below using a fourth jig 340. The fourth jig 340 has a substantially columnar shape and is flat in the horizontal direction. The fourth jig 340 includes a first part 341 having a rectangular shape being a relatively large shape in a cross-sectional view along the vertical direction, and a second part 342 having a rectangular shape being a smaller shape in the cross-sectional view along the vertical direction than the first part 341. The first part 341 and the second part 342 are integrally formed, and the second part 342 is located above the first part 341. The height of the second part 342 in the vertical direction is equal to the length, in the vertical direction, from the lower end of the second bearing 222 to the lower end of the bearing housing 207 in the first assembly 291. The outer diameter of the first part 341 is larger than the outer diameter of the bearing housing 207. The outer diameter of the second part is larger than the outer diameter of the inner ring IR of the second bearing 222 and smaller than the inner diameter of the outer ring OR. An insertion hole 340H penetrating the second part 342 in the vertical direction is formed at the center of the second part 342 in the horizontal direction. This insertion hole 340H is formed so as to have a slightly larger diameter than the shaft 277, and extends, in the horizontal direction, to a position at the center of the first part 341 and, in the vertical direction, to an intermediate position of the first part 341.

In the second step, after the fourth jig 340 as described above is placed at a horizontal surface, the second bearing 222 of the first assembly 291 is placed at the upper surface of the second part 342 of the fourth jig 340, so that the insertion hole 340H of the fourth jig 340 communicates with a through-hole of the second bearing 222, the through-hole being defined by the inner peripheral surface of the second bearing 222 (the inner peripheral surface of the inner ring IR). In this way, the inner ring IR of the second bearing 222 is supported from below by the second part 342 of the fourth jig 340, and the bearing housing 207 of the first assembly 291 is supported from below by the first part 341 of the fourth jig 340.

Subsequently, in the second step, the shaft 277 is inserted into the internal space of the bearing housing 207 of the first assembly 291 from above, and the shaft 277 is press-fitted into the above-described through-hole of the second bearing 222. The shaft 277 press-fitted into the through-hole of the second bearing 222 reaches the lower end of the insertion hole 340H of the fourth jig 340. In this way, through the second step, the inner ring IR of the second bearing 222 is supported by the shaft 277 at an angle of substantially 90° with respect to the shaft 277. That is, as a result of this second step, a second assembly 292 is obtained. In the second assembly 292, the second bearing 222 is attached substantially perpendicularly to each of the shaft 277 and the bearing housing 207 extending in the direction of the axis X.

Subsequently, a third step is performed. As illustrated in FIG. 5, in the third step, the coil spring 209 described above is inserted into the space between the shaft 277 of the second assembly 292 and the bearing housing 207. The lower end of the coil spring 209 is supported by the second bearing 222. In this way, a third assembly 293 formed by the second assembly 292 and the coil spring 209 is obtained. In the vertical direction, the position of the upper end of the coil spring 209 of the third assembly 293 corresponds to the position of the upper surface 207u of the inner peripheral surface 207i of the bearing housing 207.

Subsequently, a fourth step is performed. As illustrated in FIG. 5, in the fourth step, the first bearing 221 is press-fitted to the shaft 277 of the third assembly 293 from above using a fifth jig 350. The adhesive material 281 is applied to the outer peripheral surface of the first bearing 221 (the outer peripheral surface of the outer ring OR) in the fourth step. The fifth jig 350 has a substantially columnar shape. The fifth jig 350 includes a first part 351 having a rectangular shape being a relatively large shape in a cross-sectional view along the vertical direction, and a second part 352 having a rectangular shape being a smaller shape in the cross-sectional view along the vertical direction than the first part 351. The first part 351 and the second part 352 are integrally formed, and the second part 352 is located below the first part 351. The outer diameter of the second part 352 is larger than the outer diameter of the inner ring IR of the first bearing 221 and smaller than the inner diameter of the outer ring OR. An insertion hole 350H penetrating the second part 352 in the vertical direction is formed at the center of the second part 352 in the horizontal direction. This insertion hole 350H is formed so as to have a slightly larger diameter than the shaft 277, and extends, in the horizontal direction, to a position at the center of the first part 351 and to an intermediate position, in the vertical direction, of the first part 351.

In the fourth step, after the upper end of the shaft 277 of the third assembly 293 is inserted into a through-hole of the first bearing 221, the through-hole being defined by the inner peripheral surface of the first bearing 221 (the inner peripheral surface of the inner ring IR), the lower surface of the second part 352 of the fifth jig 350 is brought into contact with the inner ring IR of the first bearing 221. Then, the fifth jig 350 is pushed down while the shaft 277 is being inserted into the insertion hole 350H of the fifth jig 350. By pushing down the fifth jig 350 while inserting the shaft 277 into the insertion hole 350H in this way, the fifth jig 350 is guided downward in the vertical direction, and the inner ring IR of the first bearing 221 is pushed down by the fifth jig 350. In this way, the first bearing 221 is press-fitted to the upper end of the coil spring 209 of the third assembly 293. Note that, as described above, in the vertical direction, the upper end of the coil spring 209 corresponds to the position of the upper surface 207u of the inner peripheral surface 207i of the bearing housing 207. As a result, the inner ring IR of the first bearing 221 is supported by the shaft 277 at an angle of substantially 90° with respect to the shaft 277. That is, the fourth step is a step of obtaining the fourth assembly 294 by attaching the inner ring IR of the first bearing 221 to the shaft 277 at the angle of substantially 90° with respect to the shaft 277. Note that, in this fourth assembly 294, the adhesive material 281 is in an unsolidified state.

As described above, the upper surface 207u of the inner peripheral surface 207i of the bearing housing 207 protrudes further to the inner side in the radial direction than the lower surface 207d. Thus, a gap between the upper surface 207u of the inner peripheral surface 207i of the bearing housing 207 and the outer peripheral surface of the first bearing 221 press-fitted to the shaft 277 is smaller than a gap between the lower surface 207d of the inner peripheral surface 207i of the bearing housing 207 and the outer peripheral surface of the second bearing 222 press-fitted to the shaft 277. Therefore, when press-fitting the first bearing 221, even if the outer ring OR of the first bearing 221 is caused to be inclined with respect to the shaft 277 or the bearing housing 207 due to the elastic force of the coil springs 209, the outer ring OR immediately comes into contact with the upper surface 207u, and such inclination is suppressed. As a result, at the end of the fourth step, the angle formed between the outer ring OR of the first bearing 221 and each of the shaft 277 and the bearing housing 207 is inhibited from deviating from 90°.

Incidentally, since the gap between the upper surface 207u and the outer peripheral surface of the first bearing 221 is smaller than the gap between the lower surface 207d and the outer peripheral surface of the second bearing 222, the adhesive material 281 applied to the outer peripheral surface of the first bearing 221 at the fourth step cannot be accommodated in the clearance between the upper surface 207u and the outer peripheral surface of the first bearing 221, and protrudes to at least one of the upper side and the lower side of the first bearing 221. Note that, for convenience, in FIG. 5, the adhesive material 281 protruding to the upper side and the lower side of the first bearing 221 is not illustrated.

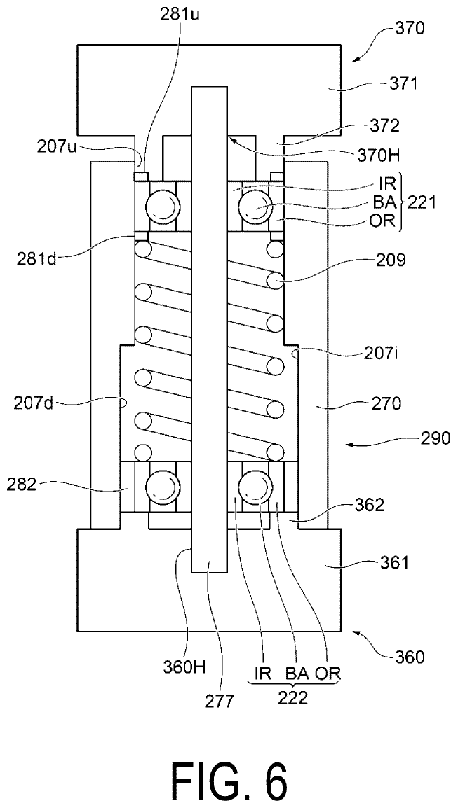

Subsequently, after the fourth jig 340 and the fifth jig 350 are removed, a fifth step is performed. As illustrated in FIG. 6, in the fifth step, a sixth jig 360 and a seventh jig 370 are used.

The sixth jig 360 has a substantially columnar shape and is flat in the horizontal direction. The sixth jig 360 includes a first part 361 having a rectangular shape in a cross-sectional view along the vertical direction, and a second part 362 having a cylindrical and ring shape and protruding upward from the upper surface of the first part 361. The outer diameter of the second part 362 of the sixth jig 360 is smaller than the diameter of the lower surface 207d of the inner peripheral surface 207i of the bearing housing 207, and the inner diameter of the second part 362 is substantially equal to the inner diameter of the outer ring OR of the second bearing 222. An insertion hole 360H slightly larger than the diameter of the shaft 277 is formed at the center in the horizontal direction of the first part 361 of the sixth jig 360.

The seventh jig 370 has a substantially columnar shape and is flat in the horizontal direction. The seventh jig 370 includes a first part 371 having a rectangular shape in a cross-sectional view along the vertical direction, and a second part 372 having a cylindrical and ring shape and protruding downward from the lower surface of the first part 371. The outer diameter of the second part 372 of the seventh jig 370 is smaller than the diameter of the upper surface 207u of the inner peripheral surface 207i of the bearing housing 207. Further, the inner diameter of the second part 372 is smaller than the inner diameter of the outer ring OR of the first bearing 221 and larger than the outer diameter of the inner ring IR. An insertion hole 370H slightly larger than the diameter of the shaft 277 is formed at the center, in the horizontal direction, of the first part 371 of the seventh jig 370.

In the fifth step, first, the sixth jig 360 is placed at a horizontal surface, and then the shaft 277 of the fourth assembly 294 is fitted into the insertion hole 360H of the sixth jig 360. As a result, the outer ring OR of the second bearing 222 of the fourth assembly 294 is supported by the sixth jig 360 from below. Subsequently, the seventh jig 370 is pushed down while the shaft 277 is being inserted into the insertion hole 370H of the seventh jig 370. By inserting the shaft 277 into the insertion hole 370H of the seventh jig 370, the seventh jig 370 is guided downward in the vertical direction. Then, the lower end of the second part 372 of the seventh jig 370 eventually comes into contact with the outer ring OR of the first bearing 221. In this way, the outer ring OR of the first bearing 221 is pressed downward by the seventh jig 370, and, on the other hand, the outer ring OR of the first bearing 221 is pressurized upward by the coil spring 209 located below. Therefore, the position of the first bearing 221 in the vertical direction is determined as a result of the pressing force from the seventh jig 370 and the pressure applied by the coil spring 209 being balanced. As a result of this state being maintained, the adhesive material 281 eventually solidifies, and the outer peripheral surface of the outer ring OR of the first bearing 221 is bonded to the upper surface 207u of the inner peripheral surface 207i of the bearing housing 207. Further, the part of the adhesive material 281 protruding to at least one of the upper side and the lower side of the first bearing 221 also solidifies, and at least one of the first part 281u and second part 281d, described above, of the adhesive material 281 is formed.

As described above, the upper surface 207u of the inner peripheral surface 207i of the bearing housing 207 protrudes further to the inner side in the radial direction than the lower surface 207d. Thus, the gap between the upper surface 207u of the inner peripheral surface 207i of the bearing housing 207 and the outer peripheral surface of the first bearing 221 is smaller than the gap between the lower surface 207d of the inner peripheral surface 207i of the bearing housing 207 and the outer peripheral surface of the second bearing 222. Therefore, at the fifth step, even if the outer ring OR of the first bearing 221 is caused to be inclined with respect to the shaft 277 or the bearing housing 207 due to the elastic force of the coil spring 209, the outer ring OR immediately comes into contact with the upper surface 207u, and such inclination is suppressed. As a result, in the fifth step, the angle formed between the outer ring OR of the first bearing 221 and each of the shaft 277 and the bearing housing 207 is inhibited from deviating from 90°.

In this way, after the fifth step, the first bearing 221 is attached to each of the shaft 277 and the bearing housing 207 at an angle of substantially 90°, and the bearing device 290 is completed.

As described above, the motor of the present invention is described with reference to the preferred embodiments, but the motor of the present invention is not limited to the configurations of the embodiments described above.

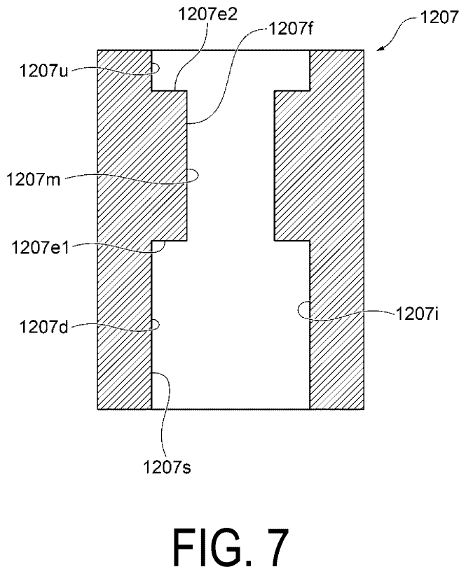

For example, the bearing housing being the holding member is not limited to the bearing housing 207 of the above-described embodiment as long as the bearing housing is constituted such that the distance between the bearing housing and the first bearing is smaller than the distance between the bearing housing and the second bearing in the radial direction. For example, a bearing housing 1207 according to a modified example as illustrated in FIG. 7 may be constituted. As illustrated in FIG. 7, an inner peripheral surface 1207i of the bearing housing 1207 includes a lower surface 1207d extending from the lower end of the inner peripheral surface 1207i to approximately half the height of the inner peripheral surface 1207i, a first stepped surface 1207e1 extending toward the inner side in the radial direction from the upper end of the lower surface 1207d, an upper surface 1207u extending along the direction of the axis X from the upper end of the inner peripheral surface 1207i to the vicinity of the upper end of the inner peripheral surface 1207i, and a second stepped surface 1207e2 extending toward the inner side in the radial direction from the lower end of the upper surface 1207u, and a protruding surface 1207m extending along the direction of the axis X from an end part, at the inner side in the radial direction, of the first stepped surface 1207e1 to an end part, at the inner side in the radial direction, of the second stepped surface 1207e2. The protruding surface 1207m includes a part 1207f opposing the first bearing 221, and the lower surface 1207d includes a part 1207s opposing the second bearing 222. By constituting such a bearing housing 1207, the distance between the bearing housing and the first bearing can be made smaller than the distance between the bearing housing and the second bearing in the radial direction.

In addition, the motor according to the present invention can be appropriately modified by a person skilled in the art according to known knowledge in the past. Such modifications are of course included in the scope of the present invention as long as these modifications still include the configuration of the present invention.

### REFERENCE SIGNS LIST

1 Motor, 207, 1207 Bearing housing (holding member), 207d, 1207d Lower surface, 207u Upper surface, 277 Shaft, 281, 282 Adhesive material, 290 Bearing device, 1207m Protruding surface

1. A motor comprising:
a shaft;
a first bearing disposed at one side in an axial direction of the shaft;
a second bearing disposed at another side in the axial direction of the shaft; and
a holding member configured to hold the first bearing and the second bearing, wherein
in a radial direction, a distance between the first bearing and the holding member is smaller than a distance between the second bearing and the holding member.

2. The motor according to claim 1, wherein
in the radial direction, a width of a surface, opposing the first bearing, of the holding member is larger than a width of a surface, opposing the second bearing, of the holding member.

3. The motor according to claim 1, wherein
an adhesive material is disposed at the other side in the axial direction of the first bearing, and the first bearing and the holding member are bonded to each other by the adhesive material.

4. The motor according to claim 1, wherein
an adhesive material is disposed at the one side in the axial direction of the first bearing, and the first bearing and the holding member are bonded to each other by the adhesive material.

5. The motor according to claim 1, wherein
the second bearing and the holding member are bonded to each other by an adhesive material.
